(19) United States
(12) Patent Application Publication
(10) Pub. No.: US 2019/0049007 A1
(43) Pub. Date: Feb. 14, 2019

(54) SEALING RING HAVING A POROUS LAYER

(71) Applicant: EtaGen, Inc., Menlo Park, CA (US)

(72) Inventor: Jodie Prudhomme, San Francisco, CA (US)

(21) Appl. No.: 16/059,976

(22) Filed: Aug. 9, 2018

Related U.S. Application Data
(60) Provisional application No. 62/543,294, filed on Aug. 9, 2017.

(51) Int. Cl. F16J 9/12; F16J 9/28; F16J 15/16

(52) U.S. Cl. CPC F16J 9/12; F16J 15/162; F16J 9/28

(57) ABSTRACT

A sealing ring segment of a sealing ring assembly may include three layers. The middle layer is permeable to gas, thus allowing radial pressure-balancing on the sealing ring segment to reduce wear. The gas-permeable allows gas to permeate from a high-pressure region to a clearance gap between a radially outer surface of the segment and a bore of a cylinder. The flow of gas affects the pressure at the radially outer surface, thus reducing the resultant radial outward force on the segment, as compared to no gas permeation. The gas-permeable layer may be porous, sintered, or have any other suitable structure having suitable gas permeability properties. The gas-permeable layer may be positioned central or rearward axially, in relation to the outer layers. The gas-permeable layer may extend the full radial thickness of the sealing ring segment.

The present disclosure is directed towards a piston seal ring and, more particularly, the present disclosure is directed towards a piston seal ring having a porous layer. This application claims the benefit of U.S. Provisional Patent Application No. 62/543,294 filed Aug. 9, 2017, the disclosure of which is hereby incorporated by reference herein in its entirety.

### BACKGROUND

A sealing ring typically maintains contact with a cylinder of a piston-cylinder device in order to create a seal and this is accomplished by gas pressure on the inner surface of the ring pushing radially outward. This outward pressure is reacted by contact with the cylinder wall. Larger gas pressure increases the contact pressure between the ring and cylinder. In the absence of lubricating oil, the sealing ring may wear. Use of a self-lubricating material for the seal reduces scuffing or galling failures, but results in a relatively high wear rate as the material readily abrades. The wear rate is related to the contact pressure experienced at the sliding interface (e.g., the higher the contact pressure the higher the wear rate).

### SUMMARY

In some embodiments, the present disclosure is directed to a sealing ring segment. The sealing ring segment includes a first layer, a second layer, and a third layer. The second layer is adjacent to and rearward of the first layer, and the third layer is adjacent to and rearward of the second layer. The first layer and the third layer are impermeable to gas, while the second layer is permeable to gas. For example, the layers may be stacked in the axial direction to form the sealing ring segment.

In some embodiments, the sealing ring segment includes a radially inner face, and a radially outer face configured to seal against a bore. In some embodiments, the at least one ring segment is configured to allow a gas of a high-pressure region to permeate the second layer from the radially inner face at least radially to reach the radially outer face. In some embodiments, gas permeating the second layer to reach the radially outer face affects a pressure at the radially outer face. For example, high pressure gas from a compression region contacts the radially inner surface, permeate the second layer and reach the radially outer face, thereby increasing a pressure at the radially outer face relative to a pressure with no gas permeation. To illustrate, the increased pressure aids in radially balancing forces on the sealing segment to reduce a wear rate of the radially outer face against the bore.

In some embodiments, the second layer includes a porous material permeable to the gas. For example, in some embodiments, the porosity is such that the permeation of the gas through the second layer is sufficient to affect the pressure between the radially outer face and the bore.

In some embodiments, the second layer comprises a sintered material permeable to the gas. For example, in some embodiments, the gas transport properties of the sintered material are such that the permeation of the gas through the second layer is sufficient to affect the pressure between the radially outer face and the bore.

In some embodiments, at least one of the first layer, the second layer, and the third layer includes a respective self-lubricating material.

In some embodiments, at least one of the first layer, the second layer, and the third layer includes a graphite-based material.

In some embodiments, the first layer includes a first radial thickness, the second layer includes a second radial thickness and the third layer includes a third radial thickness. In some embodiments, the first, the second, and the third radial thicknesses are substantially the same. In some embodiments, each layer has a unique thickness. For example, in some embodiments, the second layer is thinner than the first and third layers.

The first layer includes a first axial thickness, the second layer includes a second axial thickness, and the third layer includes a third axial thickness. The first axial thickness, the second axial thickness, and the third axial thickness sum to a total axial thickness. In some embodiments, for example, the second axial thickness is 40% or less than the total axial thickness.

In some embodiments, the present disclosure is directed to a piston assembly. The piston assembly includes a piston having a circumferential groove, and a sealing ring assembly arranged in the circumferential groove. The sealing ring assembly includes at least one sealing ring segment.

In some embodiments, the present disclosure is directed to a device. The device includes a cylinder having a bore, and a piston assembly arranged to move axially in the bore. The piston assembly includes a piston having a circumferential groove and a sealing ring assembly arranged in the circumferential groove. The sealing ring assembly includes at least one sealing ring segment.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a cross-sectional view of an illustrative piston and cylinder assembly, in accordance with some embodiments of the present disclosure;

FIG. 2 shows a perspective view of an illustrative sealing ring segment, in accordance with some embodiments of the present disclosure;

FIG. 3 shows a cross-sectional view of an illustrative sealing ring segment, in accordance with some embodiments of the present disclosure;

FIG. 4 shows a cross-sectional view of an illustrative sealing ring segment with gas-permeation, in accordance with some embodiments of the present disclosure; and

FIG. 5 shows a cross-sectional view of an illustrative device including two free piston assemblies that include respective sealing ring assemblies, in accordance with some embodiments of the present disclosure.

### DETAILED DESCRIPTION

In some embodiments, the present disclosure is directed to a pressure-source feature for controlling a pressure distribution across a sealing ring assembly, or portion thereof, in a piston-cylinder device. For example, a sealing ring assembly may include a sealing ring segment having a porous, gas permeable layer that is arranged (e.g., affixed or otherwise attached) in place between two non-gas permeable layers.

As used herein, a “ring segment” shall refer to a sealing element extending for an azimuthal angle greater than zero degrees, having a radially outer surface, and configured to seal at least along a portion of the radially outer surface against a bore. A ring segment may include end faces, if not azimuthally contiguous around the full bore.

As used herein, a “ring” shall refer to a sealing element including at least one ring segment, which may be, but need not be, azimuthally contiguous along a bore. For example, a ring may include one ring segment, in which case these terms overlap. In a further example, a ring may include four ring segments, in which case the ring refers to the collective of the four ring segments. A ring may include, but need not include, one or more interfaces between one or more ring segments. A “ring” shall also refer to a sealing element including at least one ring segment configured to seal against a land of a piston.

As used herein, a “gap cover element” shall refer to a sealing element configured to seal against one or more ring segments at an interface, and to seal against at least a portion of a bore during wear of the one or more ring segments. While a gap cover element may function as a ring segment as the ring wears, for purposes of the discussion in the present disclosure, a gap cover element is not considered to be a ring segment for purposes of clarity.

As used herein, a “sealing ring assembly” shall refer to an assembly of one or more rings, and sometimes also one or more gap covers elements, configured to engage with a piston and configured to seal between a high-pressure region and a low-pressure region of a cylinder. For example, a single ring segment may be a ring and a sealing ring assembly. In a further example, several ring segments and corresponding gap covers may be a sealing ring assembly.

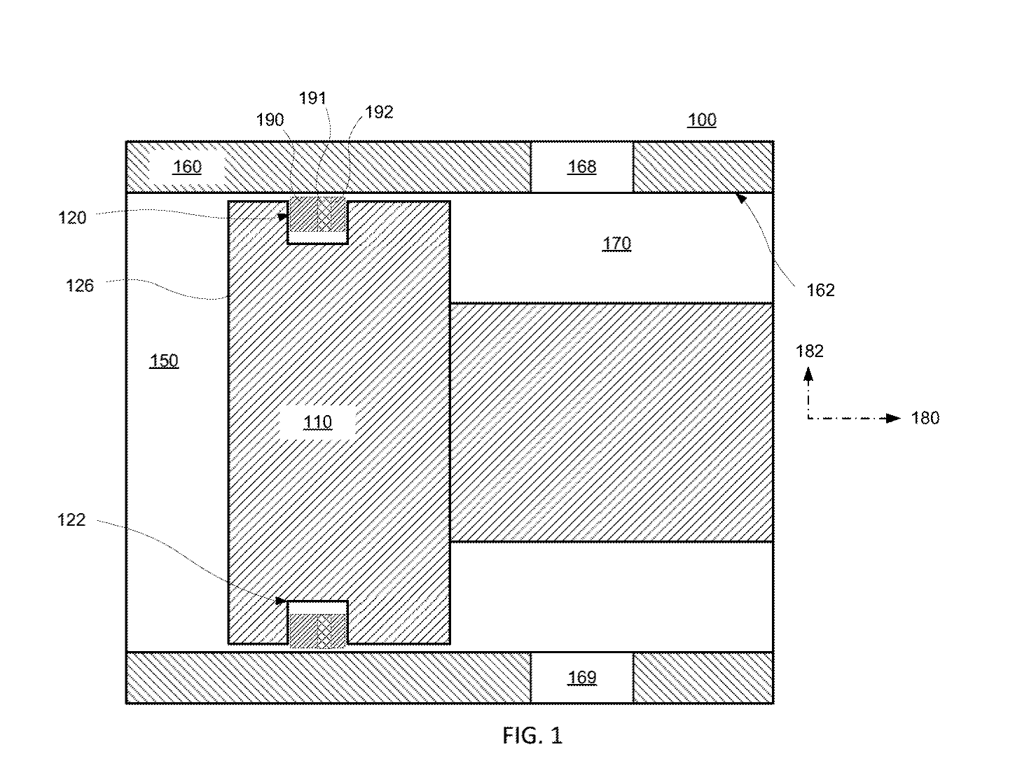

FIG. 1 shows a cross section view of illustrative piston and cylinder assembly 100 including sealing ring assembly 120, in accordance with some embodiments of the present disclosure. Cylinder 160 may include bore 162, which is the inner cylindrical surface in which piston assembly 110 travels (e.g., along axis 180). Piston assembly 110 may include piston 126, which includes a sealing ring groove 122, in which sealing ring assembly 120 is configured to be arranged and translate with piston 126. As piston assembly 110 translates along axis 180 (e.g., during an engine cycle), in cylinder 160, the gas pressure in high pressure region 150 may change (e.g., high pressure region 150 may be closed with a cylinder head or an opposing piston). For example, as piston assembly 110 moves to the left, the pressure in high pressure region 150 may increase. Low-pressure region 170, located to the rear (e.g., axis 180 is directed in the rearward direction) of the sealing ring assembly may be at a gas pressure below the pressure of high pressure region 150 for at least some, if not most, of a stroke or cycle. The pressure ranges in high pressure region 150 and low-pressure region 170 may be any suitable ranges (e.g., sub-atmospheric pressure to well over 250 bar), and may depend on compression ratio, breathing details (e.g., boost pressure, pressure waves, port timing), losses, thermochemical properties of gases, and reaction thereof. Accordingly, the sealing ring assemblies described herein may be used to seal any suitable high-pressure region and low-pressure region, having any suitable pressure ranges. For example, in some embodiments, low-pressure region 170 may interact flow-wise with intake or exhaust ducting that is in communication with ports 168 or 169 and be maintained relatively near pressure in the ducting. In an illustrative example, low pressure region 170 may open to intake breathing ports and may be at a pressure near to or strongly affected by (e.g., on average) an intake pressure (e.g., a boost pressure). In a further illustrative example, low pressure region 170 may open to exhaust breathing ports and may be at a pressure near to or strongly affected by (e.g., on average) an exhaust pressure. In accordance with the present disclosure, sealing ring assemblies may be used to seal high pressure regions from low pressure regions for at least part of a stroke or cycle of a piston and cylinder assembly. It will be understood that the “front” of sealing ring assembly 120 refers to the face axially nearest high-pressure region 150, and the “rear” of sealing ring assembly 120 refers to the face axially nearest low-pressure region 170.

It will be understood that unless otherwise specified, all pressures referred to herein are in absolute units (e.g., not gage or relative).

In some embodiments, low-pressure region 170 may include, communicate gas pressure with, or otherwise be open to ports 168 and 169 for gas exchange. For example, ports 168 and 169 may be exhaust ports, intake ports, or both. Ports may be, but need not be, opened and closed using valves. For example, in some embodiments, ports 168 and 169 refer to openings coupled to a manifold or other flow plenum, without valves included (e.g., flow is control by covering and uncovering ports 168 and 169 by ring 120). In a further example, in some embodiments, ports 168 and 169 refer to openings coupled to a manifold or other flow plenum, with valves included to control flow profiles and timing. The term “valve” may refer to any actuated flow controller or other actuated mechanism for selectively passing matter through an opening, including but not limited to: ball valves, plug valves, butterfly valves, choke valves, check valves, gate valves, leaf valves, piston valves, poppet valves, rotary valves, slide valves, solenoid valves, 2-way valves, or 3-way valves. Valves may be actuated by any means, including but not limited to: mechanical, electrical, magnetic, camshaft-driven, hydraulic, or pneumatic means.

In some embodiments, sealing ring assembly 120 may maintain contact with or maintain a clearance gap with, bore 162 to create the seal. This is accomplished by gas pressure from high-pressure region 150 acting on the inner surface of sealing ring assembly 120 to push the ring assembly 120 radially outward (e.g., along axis 182). This outward pressure is reacted by contact with bore 162 of cylinder 160, pressure at the radially outer face of sealing ring assembly 120, or a combination thereof. The rate at which sliding wear removes material from the outer surface of sealing ring assembly 120 is also a function of the resulting contact pressure (e.g., higher contact pressure increases the wear rate). Accordingly, it is usually desirable to reduce the net outward pressure, and therefore the contact pressure, in order to reduce wear rate.

Sealing ring assembly 120, as illustrated in FIG. 1, includes first layer 190, second layer 191, and third layer 192. First layer 190 and third layer 192 are substantially impermeable to gas, while second layer 191 is permeable to gas. In some embodiments, the second layer 191 of sealing ring assembly 120 is connected via a passage to (not shown), or otherwise open to, high-pressure gas of high-pressure region 150. Gas permeates second layer 191, at least in the radial direction, to reach the radially outer surface of sealing ring assembly 120. This creates a region of high gas pressure (e.g., relative to the condition if no permeable layer was present) pressing radially inward on sealing ring assembly 120 (e.g., offsetting or otherwise counteracting the outward force). Accordingly, the net radially outward force on sealing ring assembly 120 may be reduced. The gas pressure necessarily decreases from high-pressure region 150 to low-pressure region 170 as it passes across the seal created by sealing ring assembly 120. By providing high pressure gas to the radially outer face, second layer 191 maintains high pressure between the front of the seal and the radially outer face of second layer 191. Thus, the pressure drop from high-to-low primarily occurs to the rear of second layer 191 (e.g., at or along third layer 192).

It will be understood that high-pressure and low-pressure may refer to transient pressure states of a piston and cylinder device. For example, referencing an engine cycle, the high-pressure boundary of a sealing ring assembly may have a pressure greater than a low-pressure boundary of the sealing ring assembly for most of the engine cycle (e.g., except during breathing or near-breathing portions of the cycle). Accordingly, high-pressure and low-pressure are relative and depend on the conditions of the gas being sealed. It will also be understood that a sealing ring assembly may seal differently at different positions in a cycle. For example, a sealing ring assembly may always seal a high-pressure region from a low-pressure region. In a further example, a sealing ring assembly may seal a high-pressure region from a low-pressure region as long as the pressure in the high-pressure region is greater than the pressure in the low-pressure region.

In some embodiments, sealing ring assembly 120 may deposit material on bore 162 of cylinder 160. Deposited material may lubricate the bore-to-sealing ring assembly interface between bore 162 and sealing ring assembly 120. Accordingly, in some embodiments, piston and cylinder assembly 1100 may operate without liquid for lubrication (e.g., oil). In some embodiments, a layer of material from sealing ring assembly 120 may act as a solid lubricant on bore 162. It will be understood that sealing ring assembly 120 may seal against bore 162, a layer deposited thereon, or both during operation.

In some embodiments, piston 126 may be an open-faced piston. For example, piston 126 may include openings, cutouts, or other fluid paths from high pressure region 150 to ring groove 122. Accordingly, in some embodiments employing an open-faced piston, the inner radial surfaces (e.g., referencing radial direction 182 in FIG. 1) of sealing ring assembly 120 may be exposed to gas pressure of high pressure region 150.

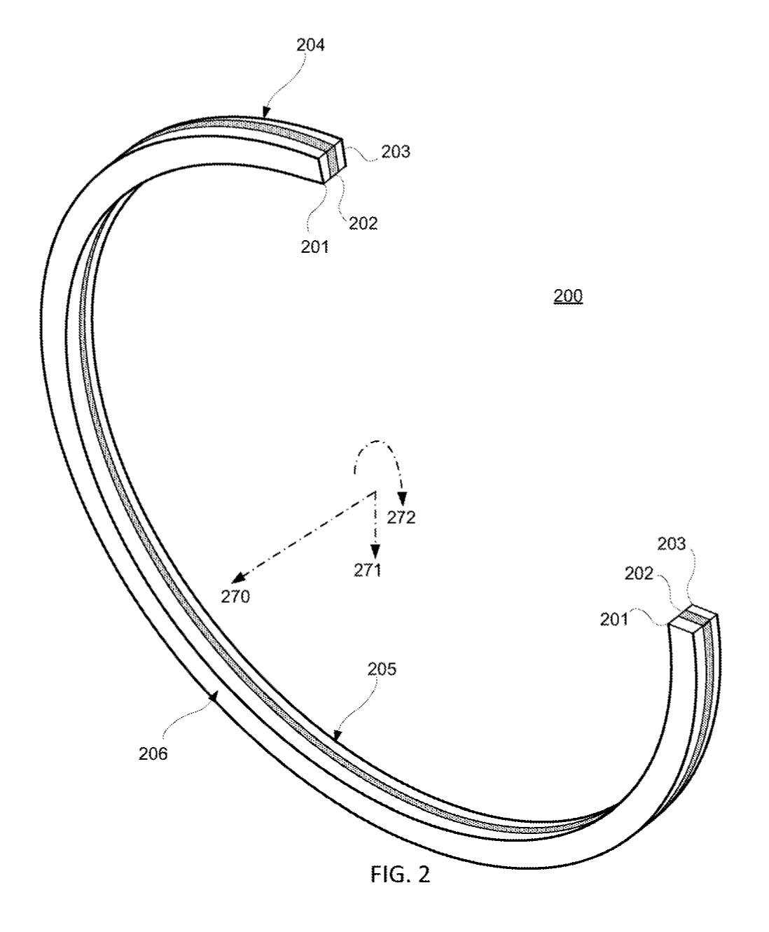

FIG. 2 shows a perspective view of sealing ring segment 200, in accordance with some embodiments of the present disclosure. In FIG. 2, axis 270 is in axial direction, axis 271 is in the radial direction, and axis 272 is in the azimuthal direction (e.g., around axis 270). Sealing ring segment 200 includes first layer 201, second layer 202, and third layer 203, radially outer face 204, radially inner face 205, and axially front face 206, as illustrated in FIG. 2. It will be understood that while sealing ring segment 200 includes three layers, a sealing ring segment may include any suitable number of layers (e.g., three or more), having suitable permeabilities. In some embodiments, layers 201, 202, and 203 are brazed together, bonded together, adhered together, or otherwise affixed together from three separate layers.

Although shown as a contiguous segment of approximately 270 degrees, a ring segment may extend azimuthally to any suitable extent. For example, sealing ring segment 200 and a second sealing ring (not shown) segment extending approximately 90 degrees may form a ring (e.g., together extend about 360 degrees), and two gap cover elements may be included to seal at the interfaces between the sealing ring segment. The gap cover elements, as described here illustratively, would seal the interfaces between the sealing ring segments, and possibly against the bore as well. Although layer 202 is shown in FIG. 2 as extending fully azimuthally along the layers 201 and 203, it need not (e.g., it may extend less than 270 degrees in the illustrative example of FIG. 2). For example, layer 202 need not be azimuthally continuous and radially continuous everywhere. For example, non-permeable bridges may extent through layer 202. In a further example, layer 202 may include permeable bridges, inserts, or pockets in an otherwise impermeable ring segment. Layer 202 may include any continuous, or non-continuous, permeable material that allows a gas flow radially outward to a radially outward surface.

In some embodiments, the first and third layers are made of a non-permeable graphite and the second layer (e.g., middle layer) is made of a permeable graphite such as is typically used in the production of porous air bearings. Permeability, also referred to herein as gas-phase permeability and gas-permeability, is a proportionality constant between gas velocity (e.g., a Darcy velocity, space velocity, or volumetric flow rate per area) and gas-phase pressure gradient in a porous medium (e.g., having a relatively large surface area to volume ratio as compared to a duct or bulk passage). A larger permeability corresponds to a larger flow rate (e.g., higher velocity). For example, as a material becomes more permeable, a larger flow rate of gas will occur for a given pressure differential across the material. Accordingly, a gas-permeable layer as referred to herein has a permeability within a suitable range. A non-permeable layer has a permeability that is relatively less than that of the gas-permeable layer by any suitable amount (e.g., by an order or magnitude or more). Gas-permeable, graphite-based materials (e.g., air bearing grade graphite materials) typically have a permeability on the order of 1e−14 m̂2, and typically ranging from 1e−16 to 1e−10 m̂2 depending on the grade, treatment, and direction of flow, for example. The dynamic response of the gas permeable layer (e.g., second layer 202 of FIG. 2) can be adjusted by selecting a material with greater or lesser permeability. In some embodiments, the gas permeable layer includes any suitable material, graphite, another type of ceramic, or otherwise, that allows adequate gas flow and can be bonded to the front and rear layers (e.g., first layer 201 and third layer 203). A non-permeable layer may include a permeability to gas of 1e−20 or less, for example.

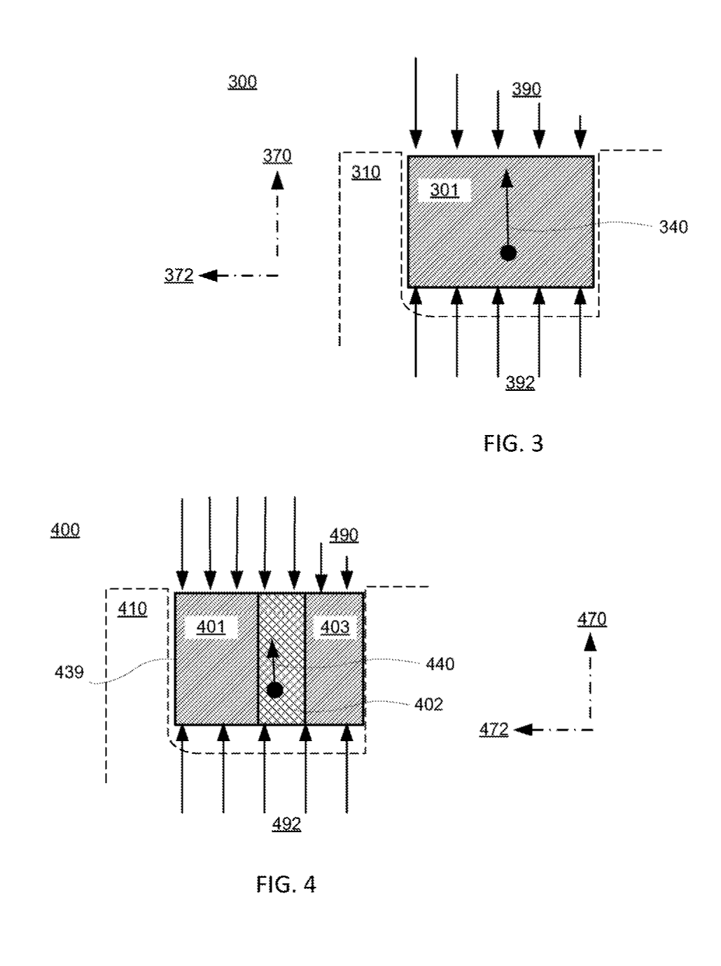

In some embodiments, the axial thickness of second layer 202 (i.e., in direction 270) may range from 5% to 80% of the full axial thickness of sealing ring segment 200 (i.e., the sum of the axial thickness of layers 201, 202, and 203). For example, in some embodiments, a second layer may be approximately 20% of the total axial thickness. In some embodiments, a second layer extends the full radial thickness of the sealing ring segment, from the inner diameter (ID) to the outer diameter (OD). For example, as illustrated in FIG. 2, second layer 202 extends from radially inner face 205 to radially outer face 204. During operation as a seal, the ID of a sealing ring segment is exposed to high pressure gas in normal operation and this exposure to the gas-permeable layer allows the gas to permeate the second layer until it reaches the OD at the boundary of a cylinder wall (i.e., a bore). This primarily radial flow establishes an axial pressure distribution across the ring to aid in balance radial pressure forces. Further descriptions of pressure forces are provided, for example, in the context of FIGS. 3-4 of the present disclosure.

In some embodiments, a gas permeable layer (i.e., a pressure compensation feature) may extend the full radial thickness of the sealing ring segment. In the context of high-wear rings, the inclusion of the gas-permeable layer may increase the potential operational life of the sealing ring segment as the pressure compensation feature is present during wear (e.g., it is not removed, worn away fully, or otherwise cease to allow gas permeation as it wears). Additionally, in some embodiments, the composite structure of a sealing ring segment having a gas-permeable layer avoids structurally weak sections (e.g., thin sections) which might be introduced if a recess, groove, or pocket were used to direct gas flow. In some embodiments, a recess, groove, or pocket may be included for performance, and configured to not significantly impact the structural strength. In some embodiments, the gas-permeable layer may be arranged towards the center or rear face of the ring. For example, the gas-permeable layer (e.g., second layer 202 of FIG. 2) may be axially centered anywhere from 45% to 95% of the total axial length of the sealing ring segment (e.g., sealing ring segment 200) from the front face (e.g., axially front face 206). The present disclosure may be applied to sealing ring assemblies, or sealing ring segments and gap cover elements thereof, that otherwise exhibit a relatively high radial wear rate. For example, the wear rate may be reduced by introducing a pressure-balancing feature such as a gas-permeable layer.

FIG. 3 shows a cross-sectional view of illustrative sealing ring segment 300, in accordance with some embodiments of the present disclosure. Coordinate axes 370 (i.e., radial), and 372 (i.e., axial) are provided in FIG. 3 for purposes of clarity. Sealing ring segment 300 is configured to be arranged in a ring groove of piston 310.

Illustrative radial pressure fields 390 (i.e., acting radially inward) and 392 (i.e., acting radially outward) may act on sealing ring segment 300 during operation. Radial pressure field 392 is directed radially outward and is created by gas from a high-pressure region acting on the radially inner surface of sealing ring segment 300. Radial pressure field 390 is directed radially inward and is created by gas in the clearance between sealing ring assembly 300 and a corresponding bore. The resultant force 340 is directed radially outward, pushing sealing ring segment 300 radially outward. The magnitude of resultant force 340 may impact a wear rate of sealing ring segment 300. For example, a larger resultant force may cause a larger normal force of a sealing ring assembly against a bore, which during motion of the sealing ring assembly may lead to increased friction force. Accordingly, increased friction work may result in increased wear on the sealing ring assembly.

FIG. 4 shows a cross-sectional view of illustrative sealing ring segment 400 with gas-permeation (e.g., via second layer 402), in accordance with some embodiments of the present disclosure. Coordinate axes 470 (i.e., radial), and 472 (i.e., axial) are provided in FIG. 4 for purposes of clarity. Sealing ring segment 400 includes first layer 401, second layer 402, and third layer 403. Sealing ring segment 400 is configured to be arranged in a ring groove of piston 410.

Illustrative radial pressure fields 490 (i.e., acting radially inward) and 492 (i.e., acting radially outward) may act on sealing ring segment 400 during operation. Radial pressure field 492 is directed radially outward, and is created by gas from a high-pressure region acting on the radially inner surface of sealing ring segment 400. Radial pressure field 490 is directed radially inward, and is created by gas in the clearance between, and asperities in, the surface of sealing ring segment 400 and a corresponding bore. For example, whether sealing ring segment 400 contacts the bore or not, gas having a corresponding pressure may be present at the interface. Radial pressure field 490 is relatively larger than radial pressure field 390 in FIG. 3, under similar conditions, due to second layer 402 which allows high pressure gas to flow and affect radial pressure field 490. The resultant force 440 is directed radially outward, pushing sealing ring segment 400 radially outward. The magnitude of resultant force 440 is less than resultant force 340. This is because, for example, radial pressure fields 392 and 492 are substantially similar, but the inward force from radial pressure field 390 is less than the inward force from radial pressure field 490 (e.g., when radial pressure fields are integrated over the surface).

Second layer 402 may be positioned axially at any suitable location (e.g., front half, central portion, or rear half) of sealing ring segment 400. In some embodiments, the farther towards the rear (axially) of sealing ring segment 400 that second layer 402 is located (e.g., centered about), the more resultant force 440, and hence wear, may be reduced. There are practical limitations, however, to how close to the rear, axially, of sealing ring segment 400 that second layer 402 may be located. This may be due to the mechanical strength of sealing ring segment 400, increased leakage, or both. In some embodiments, second layer 402 may be located in the rear half of sealing ring segment 400, axially. For example, in some embodiments, the center of second layer 402 may be located between 45% and 95% of the axial length of sealing ring segment 400 from the front face (e.g., face 439). It will be understood that the pocket location may be located at any suitable axial position (e.g., centered about any suitable axial position).

In some embodiments, to help reduce wear, second layer 402 may extend azimuthally for as much of the circumferential extent of sealing ring segment 400 as possible (e.g., extend the full azimuthal extent of a sealing ring segment). In some embodiments, second layer 402 does not intersect the splits in the sealing ring assembly (e.g., which may cause increased gas leakage and a poorer seal). For example, if a split is exposed to a low-pressure region, a leak path may be formed. In a further example, if a split is exposed to a high-pressure region, then the porous layer may extend to the split without introducing a leak path.

In some embodiments, gas in second layer 402 may be pressurized at, or near to, the pressure of a high-pressure region. In some embodiments, a hole or other passage may be formed (e.g., drilled) through piston 410, thus connecting a radially inner face of second layer 402 to gas of a high-pressure region.

It will be understood that sealing ring segments 300 and 400 of respective FIGS. 3 and 4 are illustrative. For example, sealing ring segments 300 and 400 may be included, along with optionally one or more other sealing ring segments or gap covers, as part of a sealing ring assembly. Although first layer 401 and third layer 403 are shown hatched similarly, they need not have the same material constituents. For example, first layer 401 and third layer 403 may both include graphite with a permeability below a threshold (e.g., deemed not gas-permeable). In a further example, first layer 401 and third layer 403 may each include a respective material, each respective material having a permeability below a threshold (e.g., deemed not gas-permeable).

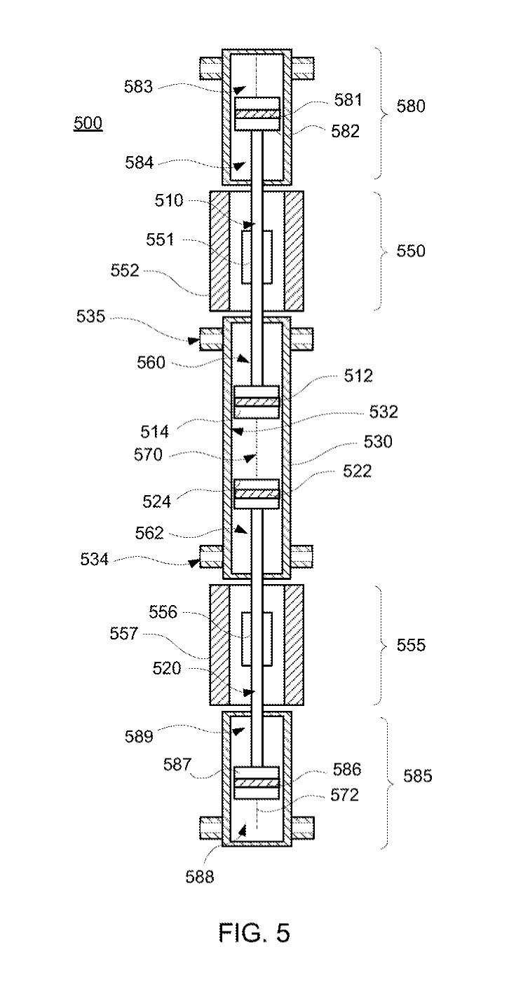

FIG. 5 shows a cross-sectional view of illustrative device 500 including two free piston assemblies 510 and 520 that include respective sealing ring assemblies 512 and 522 in accordance with some embodiments of the present disclosure. In some embodiments, device 500 may include linear electromagnetic machines 550 and 555 to convert between kinetic energy of respective free piston assemblies 510 and 520 and electrical energy. In some embodiments, device 500 may include gas regions 560 and 562, which may, for example, be at a relatively lower pressure than gas region 570 (e.g., a high-pressure region) for at least some, if not most, of a cycle (e.g., an engine cycle, or an air compression cycle). For example, gas regions 560 and 562 (e.g., low pressure regions) may be open to respective breathing ducting (e.g., an intake manifold, an intake system, an exhaust manifold, an exhaust system). To illustrate, breathing ports 534 and 535 are configured to provide reactants to, and remove exhaust from, bore 532 of cylinder 530. In a further example, gas regions 560 and 562 may be vented to atmosphere (e.g., be at about 1.01 bar absolute pressure). In some embodiments, device 500 may include gas springs 580 and 585, which may be used to store and release energy during a cycle in the form of compressed gas (e.g., a driver section). For example, free piston assemblies 510 and 520 may each include respective pistons 582 and 587, having grooves for respective sealing ring assemblies 581 and 586, to seal respective gas regions 583 and 588 (e.g., high-pressure regions) from respective gas regions 584 and 589 (e.g., low-pressure regions).

Cylinder 530 may include bore 532, centered about axis 572. In some embodiments, free piston assemblies 510 and 520 may translate along axis 572, within bore 532, allowing gas region 570 to compress and expand. For example, gas region 570 may be at relatively high pressure as compared to gas region 560 for at least some of a stroke of free piston assemblies 510 and 520 (e.g., which may translate along axis 572 in opposed piston synchronization). Sealing ring assemblies 512 and 522 may seal gas region 570 from respective gas regions 560 and 562 within bore 532. In some embodiments, free piston assemblies 510 and 520 may include respective pistons 514 and 524, and respective sealing ring assemblies 512 and 522 which may be arranged in respective corresponding grooves of pistons 514 and 524. It will be understood that gas regions 560 and 562, and gas region 570, may change volume as free piston assemblies 510 and 520 move or are otherwise positioned at different locations along axis 572. The portions of respective sealing ring assemblies 512 and 522 nearest gas region 570 are each termed the front, and the portion of sealing ring assemblies 512 and 522 nearest respective gas regions 560 and 562 are each termed the rear. Sealing ring assemblies 512 and 522 may each include a high-pressure boundary, which may each depend on a pressure in gas region 570. For example, a high-pressure boundary of sealing ring assembly 512 may be open to gas region 570 (e.g., coupled by one or more orifices, or other opening), and have a corresponding pressure the same as (e.g., if gas from gas region 570 is unthrottled in the sealing ring assembly), or less than (e.g., if gas from gas region 570 is throttled in the sealing ring assembly), the pressure of gas region 570. Sealing ring assemblies 512 and 522 may each include a low-pressure boundary, which may depend on a gas pressure in respective gas regions 560 and 562. For example, a low-pressure boundary of sealing ring assembly 512 may be open to gas region 560 and have a corresponding pressure about the same as the pressure of gas region 560. In some embodiments, as sealing ring assemblies 512 an 522 axially pass over respective ports 535 and 534 (e.g., and corresponding port bridges, although not shown), they may experience uneven, or reduced, inward force from bore 532.

In some embodiments, pistons 514 and 524 may each include one or more grooves into which one or more respective sealing ring assemblies may be arranged. For example, as shown in FIG. 5, pistons 514 and 524 may each include one groove, into which sealing ring assembly 512 and sealing ring assembly 522 may be installed, respectively. In a further example, although not shown in FIG. 5, piston 514 may include two grooves, in which two respective sealing ring assemblies may be installed. In a further example, piston 514 may include two grooves, the first sealing ring assembly 512, and the second (not shown), arranged to the rear of sealing ring assembly 512, but with its front nearer to gas region 560, thereby sealing pressure in gas region 560 to pressure between the two sealing ring assemblies (e.g., which may be less than pressure in gas region 570). Accordingly, a sealing ring assembly may be used to seal any suitable high pressure and low-pressure regions from each other.

In some embodiments, free piston assemblies 510 and 520 may include respective magnet sections 551 and 556, which interact with respective stators 552 and 557 to form respective linear electromagnetic machines 550 and 555. For example, as free piston assembly 510 translates along axis 572 (e.g., during a stroke of an engine cycle), magnet section 551 may induce current in windings of stator 552. Further, current may be supplied to respective phase windings of stator 552 to generate an electromagnetic force on free piston assembly 510 (e.g., to effect motion of free piston assembly 510).

In some embodiments, pistons 514 and 524, sealing ring assemblies 512 and 522, and cylinder 530 may be considered a piston and cylinder assembly. In some embodiments, device 500 may be an engine, an air compressor, any other suitable device having a piston and cylinder assembly, or any combination thereof. In some embodiments, device 500 need not include two free piston assemblies. For example, cylinder 530 could be closed (e.g., with a cylinder head), and free piston assembly 510 alone may translate along axis 572.

It will be understood that the present disclosure is not limited to the embodiments described herein and can be implemented in the context of any suitable system. In some suitable embodiments, the present disclosure is applicable to reciprocating engines and compressors. In some embodiments, the present disclosure is applicable to free-piston engines and compressors. In some embodiments, the present disclosure is applicable to combustion and reaction devices such as a reciprocating engine and a free-piston engine. In some embodiments, the present disclosure is applicable to non-combustion and non-reaction devices such as reciprocating compressors, free-piston heat engines, and free-piston compressors. In some embodiments, the present disclosure is applicable to gas springs. In some embodiments, the present disclosure is applicable to oil-free reciprocating and free-piston engines and compressors. In some embodiments, the present disclosure is applicable to oil-free free-piston engines with internal or external combustion or reactions. In some embodiments, the present disclosure is applicable to oil-free free-piston engines that operate with compression ignition, chemical ignition (e.g., exposure to a catalytic surface, hypergolic ignition), plasma ignition (e.g., spark ignition), thermal ignition, any other suitable energy source for ignition, or any combination thereof. In some embodiments, the present disclosure is applicable to oil-free free-piston engines that operate with gaseous fuels, liquid fuels, or both. In some embodiments, the present disclosure is applicable to linear free-piston engines. In some embodiments, the present disclosure is applicable to engines that can be combustion engines with internal combustion/reaction or any type of heat engine with external heat addition (e.g., from a heat source such as waste heat or an external reaction such as combustion).

The foregoing is merely illustrative of the principles of this disclosure, and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A sealing ring segment comprising:
a first layer substantially impermeable to gas;
a second layer permeable to gas arranged axially adjacent to and rearward of the first layer; and
a third layer substantially impermeable to gas and arranged axially adjacent to and rearward of the second layer.

2. The sealing ring segment of claim 1, further comprising:
a radially inner face; and
a radially outer face configured to seal against a bore.

3. The sealing ring segment of claim 2, wherein the at least one ring segment is configured to allow a gas of a high-pressure region to permeate the second layer from the radially inner face at least radially to reach the radially outer face.

4. The sealing ring segment of claim 3, such that gas permeating the second layer to reach the radially outer face affects a pressure at the radially outer face.

5. The sealing ring segment of claim 1, wherein the second layer comprises a porous material permeable to the gas.

6. The sealing ring segment of claim 1, wherein the second layer comprises a sintered material permeable to the gas.

7. The sealing ring segment of claim 1, wherein at least one of the first layer, the second layer, and the third layer comprises a respective self-lubricating material.

8. The sealing ring segment of claim 1, wherein at least one of the first layer, the second layer, and the third layer comprises a graphite-based material.

9. The sealing ring segment of claim 1, wherein:
the first layer comprises a first radial thickness;
the second layer comprises a second radial thickness;
the third layer comprises a third radial thickness; and
the first, the second, and the third radial thicknesses are substantially the same.

10. The sealing ring segment of claim 1, wherein:
the first layer comprises a first axial thickness;
the second layer comprises a second axial thickness;
the third layer comprises a third axial thickness;
the first axial thickness, the second axial thickness, and the third axial thickness sum to a total axial thickness; and
the second axial thickness is 40% or less than the total axial thickness.

11. A piston assembly comprising:
a piston comprising a circumferential groove; and
a sealing ring assembly arranged in the circumferential groove and comprising at least one ring segment comprising:
a first layer substantially impermeable to gas;
a second layer permeable to gas arranged axially adjacent to and rearward of the first layer; and
a third layer substantially impermeable to gas and arranged axially adjacent to and rearward of the second layer.

12. The piston assembly of claim 11, wherein the at least one ring segment further comprises:
a radially inner face; and
a radially outer face configured to seal against a bore.

13. The piston assembly of claim 12, wherein the at least one ring segment is configured to allow a gas of a high-pressure region to permeate the second layer from the radially inner face at least radially to reach the radially outer face.

14. The piston assembly of claim 13, such that gas permeating the second layer to reach the radially outer face affects a pressure at the radially outer face.

15. The piston assembly of claim 11, wherein the second layer comprises a porous material permeable to the gas.

16. The piston assembly of claim 11, wherein the second layer comprises a sintered material permeable to the gas.

17. The piston assembly of claim 11, wherein at least one of the first layer, the second layer, and the third layer comprises a respective self-lubricating material.

18. The piston assembly of claim 11, wherein at least one of the first layer, the second layer, and the third layer comprises a graphite-based material.

19. The piston assembly of claim 11, wherein:
the first layer comprises a first radial thickness;
the second layer comprises a second radial thickness;
the third layer comprises a third radial thickness; and
the first, the second, and the third radial thicknesses are substantially the same.

20. The piston assembly of claim 11, wherein:
the first layer comprises a first axial thickness;
the second layer comprises a second axial thickness;
the third layer comprises a third axial thickness;
the first axial thickness, the second axial thickness, and the third axial thickness sum to a total axial thickness; and
the second axial thickness is 40% or less than the total axial thickness.

21. A device comprising:
a cylinder comprising a bore; and
a piston assembly arranged to move axially in the bore and comprising:
a piston comprising a circumferential groove, and
a sealing ring assembly arranged in the circumferential groove, configured to seal against the bore, and comprising at least one ring segment comprising:
a first layer substantially impermeable to gas,
a second layer permeable to gas arranged axially adjacent to and rearward of the first layer, and
a third layer substantially impermeable to gas and arranged axially adjacent to and rearward of the second layer.

22. The device of claim 21, wherein the at least one ring segment further comprises:
a radially inner face; and
a radially outer face configured to seal against the bore.

23. The device of claim 22, wherein the at least one ring segment is configured to allow a gas of a high-pressure region of the bore to permeate the second layer from the radially inner face at least radially to reach the radially outer face.

24. The device of claim 23, such that gas permeating the second layer to reach the radially outer face affects a pressure between the radially outer face and the bore.

25. The device of claim 21, wherein the second layer comprises a porous material permeable to the gas.

26. The device of claim 21, wherein the second layer comprises a sintered material permeable to the gas.

27. The device of claim 21, wherein at least one of the first layer, the second layer, and the third layer comprises a respective self-lubricating material.

28. The device of claim 21, wherein at least one of the first layer, the second layer, and the third layer comprises a graphite-based material.

29. The device of claim 21, wherein:
the first layer comprises a first radial thickness;
the second layer comprises a second radial thickness;
the third layer comprises a third radial thickness; and
the first, the second, and the third radial thicknesses are substantially the same.

30. The device of claim 21, wherein:
the first layer comprises a first axial thickness;
the second layer comprises a second axial thickness;
the third layer comprises a third axial thickness;
the first axial thickness, the second axial thickness, and the third axial thickness sum to a total axial thickness; and
the second axial thickness is 40% or less than the total axial thickness.
